(19) United States
(12) Patent Application Publication
(10) Pub. No.: US 2008/0126884 A1
(43) Pub. Date: May 29, 2008

(54) Method for providing detailed information and support regarding an event message

(75) Inventors: Wolfgang Stempfer, Erlangen (DE); Axel Fischer, Wermsdorf (DE)

Correspondence Address: SCHIFF HARDIN, LLP;PATENT DEPARTMENT, 6600 SEARS TOWER, CHICAGO, IL, 60606-6473, US

(73) Assignee: Siemens Aktiengesellschaft

(21) Appl. No.: 11/605,911

(22) Filed: Nov. 28, 2006

(51) Int. Cl. G06F 11/07; G06F 11/30

(52) U.S. Cl. 714/49; 714/57; 714/E11.024; 714/E11.179

(57) ABSTRACT

A method provides information and support related to an event message that is stored in an event log. A user display device displays the message and its description to a user. Recommended actions to the user are provided and user selectable options related to the message are presented, wherein the user selectable options include: displaying further documentation or a link to further documentation to the user; displaying a statical overview related to the message; executing a test routine related to the message; and accepting feedback information from the user that is supplied to a remote location.

### BACKGROUND

The present invention relates to a method for providing detailed information and support regarding an event message.

Medical systems often involve numerous complex elements that are interconnected and interrelated to one another. In these systems, various error and diagnostic messages may be presented to users or administrators of such systems. It is common to record error and diagnostic messages into a storage area, such as a log file.

Currently, the descriptions of the messages logged in an error log in medical systems are often insufficient for troubleshooting or problem-solving,o r may simply be very cryptic and difficult to interpret. This is because during the development process of the system sub-components,a n effect resulting in the event of an error can only be partially assessed for the user or cannot be assessed at all, and detailed descriptions cannot be logged in the error log. This can create a problem for service personnel or system administrators who frequently require more detailed information related to the error in order to properly diagnose the problem. Know systems rely upon the expertise of a respective service person as well as on the availability of training documents, and possibly the ability to contact headquarter support centers for a given element or the system.

### SUMMARY

Using an event log reader, the content of an error log is shown to the service personnel as text in the form of a table. An error message normally contains an error identification number, an identification for the component causing the error, and (as mentioned above) an insufficient description.

According to various embodiments of the invention, a particular error message is selected, e.g., via a mouse click or other know selection mechanism, which triggers a display of various support functions, e.g., in a separate window, to the service personnel. By providing such resources, a faster and more efficient troubleshooting can be achieved. Furthermore, since this functionality can also be implemented remotely, an increase of the first visit fix rate can be achieved.

Specifically, a method is utilized for providing information and support related to an event message, comprising: storing an event message in an event log; providing a display of the message and its description to a user on a user display device; providing a display of recommended actions to the user on the user display device; presenting user selectable options related to the message, wherein the user selectable options include: displaying further documentation or a link to further documentation to the user; displaying a statistical overview related to the message; executing a test routine related to the message; and accepting feedback information from the user that is supplied to a remote location.

### DESCRIPTION OF THE DRAWINGS

The invention is explained below with reference to various embodiments illustrated in the drawings and following description. The Figure is a block diagram illustrating components of the system.

### DETAILED DESCRIPTION OF THE PREFERRED EMBODIMENTS

The Figure illustrates the various components of the system 10 according to a preferred embodiment.

Various events occur in applications running within a system and may be recorded as messages 22 in an event log. An event log reader 20 accesses multiple log messages 22 in an event log file or database. A selected message out of the EventLog Reader view is displayed in a detailed message window 30 on a display device of a computer system. A detailed description 32 of the appertaining error is displayed, along with recommended actions 34 (such as measurement points or modules to be exchanged) in order to solve the problem. This information 32, 34 may be stored in an encrypted form in the system, and can be associated with a respective measurement upon retrieval via an identification number. Since such information 32, 34 can be further developed over the life cycle of the system, it can also be updated 14 via an update process (which can also be remotely implemented).

The system 10 also provides further mechanisms that may be utilized by operating a selection mechanism, e.g., buttons on a display 36. One of the selections provides further documentation 40 and/or a link to further related documentation on the system 42. This information can be updated so that it is always current. The electronic documentation 40, 42 automatically available on the system can include information such as troubleshooting instructions, instructions for various settings, or function descriptions that contain further information regarding a particular error image. This permits the user to access relevant information without having to search in paper documents.

A further selectable option gives a statistical overview 50 related to a particular selected errors or events. Such information can include, e.g., how often and at which point in time the respective event or error has occurred in the system 52.

A further selectable option permits tests 60 to be implemented. For example, a special test 62 could be executed in order to reproduce a particular error or to localize corresponding components for problem resolution 80. If no explicit test for those errors is available,a new scan within the event log is triggered in such a way that a known or predetermined message combination is searched, since a problem or malfunction can log several messages in combination in the log file. If such a combination is found,a further related test, linked to the message combination, can be initiated. This leads to the cause of the problem more quickly.

A further selectable option lets service personnel provide feedback 70 via an input field of a display in which the service personnel can input 72 their own experiences or critiques with regard to the respective offered information, which is then transferred from the system to a service headquarters 12 via an existing remote connection and thus serves for further improvement of this information.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential ” or “critical”. Numerous modifications and adaptations will be readily apparent to those skilled in this art without departing from the spirit and scope of the present invention.

What is claimed is:

1. A method for providing information and support related to an event message, comprising:
storing an event message in an event log;
providing a display of the message and its description to a user on a user display device;
providing a display of recommended actions to the user on the user display device;
presenting user selectable options related to the message, wherein the user selectable options include:
displaying further documentation or a link to further documentation to the user;
displaying a statistical overview related to the message;
executing a test routine related to the message; and
accepting feedback information from the user that is supplied to a remote location.

2. The method according to claim 1, further comprising:
updating, by the remote location, the message description, recommended actions, or further documentation based on the feedback received.

3. The method according to claim 1, wherein the test routine serves to locate or isolate a particular problem related to the message.

4. The method according to claim 1, further comprising:
updating, by the remote location, the test routines.

5. The method according to claim 1, further comprising:
searching the event log for a predetermined message combination; and initiating a further related test based on a located message combination.
